(19) United States
(12) Patent Application Publication
(10) Pub. No.: US 2015/0071541 A1
(43) Pub. Date: Mar. 12, 2015

(54) AUTOMATED METHOD FOR MEASURING, CLASSIFYING, AND MATCHING THE DYNAMICS AND INFORMATION PASSING OF SINGLE OBJECTS WITHIN ONE OR MORE IMAGES

(71) Applicant: Rice University, Houston, TX (US)

(72) Inventors: Amina Ann Qutub, Houston, TX (US); David Thomas Ryan, Houston, TX (US); Byron Lindsay Long, Houston, TX (US); Rebecca Zaunbrecher, Concord, MA (US); Chenyue Hu, Hangzhou (CN); John Hundley Slater, Durham, NC (US); Jingzhe Hu, Guangzhou (CN)

(21) Appl. No.: 14/459,266

(22) Filed: Aug. 13, 2014

Related U.S. Application Data
(60) Provisional application No. 61/865,642, filed on Aug. 14, 2013.

(51) Int. Cl. G06K 9/00; G06T 7/00

(52) U.S. Cl. CPC G06K 9/00577; G06T 7/0091; G06T 7/0093; G06T 2207/20036
USPC 382/173

(57) ABSTRACT

An apparatus, computer-readable medium, and computer-implemented method for identifying, classifying, and utilizing object information in one or more image includes receiving an image including a plurality of objects, segmenting the image to identify one or more objects in the plurality of objects, analyzing the one or more objects to determine one or more morphological metrics associated with each of the one or more objects, determining the connectivity of the one or more objects to each other based at least in part on a graphical analysis of the one or more objects, and mapping the connectivity of the one or more objects to the morphological metrics associated with the one or more objects.

### RELATED APPLICATION DATA

This application claims priority to U.S. Provisional Application No. 61/865,642, filed Aug. 14, 2013, the disclosure of which is hereby incorporated in its entirety.

### GOVERNMENT GRANT INFORMATION

This invention was made with government support under Grant Number CBET-1150645 awarded by the National Science Foundation. The government has certain rights in the invention.

### BACKGROUND

Quantitative information about objects within an image can provide information critical to identification, decision making and classification. For example, characterization of single or multiple biological cells from microscope images can help determine therapeutic strategies for patients, or aid with the identification of a person in a large crowd of people.

There are a variety of segmentation methods available that can be used to isolate and analyze objects of an image. However, these methods can be time-consuming, as they require significant user inputs and adjustments of image processing parameters, and biased, as they are often prone to both user error and variable interpretation of object boundaries.

Additionally, while prior image segmentation techniques allow for segmentation of components in a single image, they do not allow for automated processing of multiple images. Many raw images require pre-processing and adjustment before segmentation can effectively be used to locate objects of interest in the field of view. Even when the images seem to be very similar, the properties of objects in one image may dictate the need for very different processing and parameter values than those required by another image.

Once the image has been segmented, an additional problem is that of determining the properties of objects that have been segmented. While the human eye quickly recognizes patterns across images, automated means of identifying and classifying objects often are unable to capture complex patterns because of their reliance on a small set of metrics, metrics not optimized for a particular application, or metrics that are considered without regard to an object's local environment and communication with other objects.

Furthermore, there is currently no optimized and automatic way to search for objects of interest within images, as commercial image searches so far have focused on whole image searches.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. A more complete understanding of this disclosure may be acquired by referring to the following description taken in combination with the accompanying figures.

FIG. 1 illustrates a flowchart for identifying, classifying, and utilizing object information in one or more images according to an exemplary embodiment.

FIGS. 2A-F illustrate an example of the watershed method applied to an image of cells according to an exemplary embodiment. (FIG. 2A) Example pixel intensities from an image. (B) Grayscale pixel values. (FIG. 2C) Topography interpretation of grayscale pixels. (FIG. 2D) Regions of different cells identified from topography (black). (FIG. 2E) Local regions flooded following topographical contours by introducing water at elevation minima (black). (FIG. 2F) Uniting bodies of water form a single body when they do not join regions from different markers. Boundaries are formed at places where bodies of water from different markers meet (striped).

FIGS. 3A-C illustrate a comparison of the watershed image segmentation technique and manual object identification in an image. (FIG. 3A) Original image of a cell monolayer. (FIG. 3B) Hand draw masks. (FIG. 3C) Results of the automated, adaptive watershed approach.

FIGS. 4A-I illustrate pre-processing steps that can be utilized by the system when performing watershed segmentation. (FIG. 4A) Original image. (FIG. 4B) Histogram equalization. (FIG. 4C) 2-D Gaussian filter. (FIG. 4D) Dilated image with global image thresholding. (FIG. 4E) Baseline global image thresholding. (FIG. 4F) Small objects removed from D. (FIG. 4G) Complement of filtered image, C. (FIG. 4H) Minimum imposed image. (FIG. 4I) Resulting mask outlines.

FIGS. 5-6 illustrate some examples of successful segmentation.

FIGS. 7-8 illustrate example categories of image-based metrics according to an exemplary embodiment.

FIGS. 9A-C illustrate the translation of object location and adjacency to a connectivity graph. (FIG. 9A) Each object (cell) can be characterized for its network properties. Network properties are determined by a graph-based analysis, where both contact adjacency and distance between object centroids define edges. (FIG. 9B) Local connectivity of single objects within an image and global properties of a multicellular network can be assessed through this graphical approach. (FIG. 9C) An object (e.g., cell) can be classified into a phenotype based on cluster analysis of a set of network connectivity metrics.

FIGS. 10A-B illustrate mapping of connectivity to morphology. (FIG. 10A) and network connectivity (FIG. 10B) provides the ability to map network state and information passing across time to specific object features and develop a predictive model of morphological/spatial changes in time.

FIG. 11 illustrates an example of cluster analysis.

FIG. 12 illustrates a state machine which can be developed from a cluster.

FIGS. 13A-C illustrate a comparison between a manual watershed method and automated watershed segmentation. (FIG. 13A) Number of cells from each cluster corresponding to each growth condition. (FIG. 13B) Fractional distribution of conditions among clusters. (FIG. 13C) Fraction of conditions found in each cluster.

FIG. 14 illustrates representative average cells from four clusters identified by common features of a group. We can use the qualitative images, which map to our quantitative metrics, to visualize physical properties of objects in each identified phenotype.

FIG. 15 illustrates an exemplary computing environment that can be used to carry out the method identifying, classifying, and utilizing object information in one or more images according to an exemplary embodiment.

FIG. 16 illustrates a schematic of a possible computing infrastructure according to an exemplary embodiment. Images are collected on a microscope (red), immediately recognized and classified by our algorithms embedded in the microscope or on the microscope workstation. Images can also can be transferred to a database (green) and processed through our algorithms by a computing cluster (blue) which then stores the results with the original image data on the database. The image search can be directly applied to all data and objects within images in the database.

### DETAILED DESCRIPTION

The inventors have identified a need for a system which would allow users to automatically segment and classify objects in one or more images, determine object properties, identify how objects are connected to each other, and match object features and morphology with object network connectivity and object communication. Additionally, the inventors have identified a need for an image search system which allows users to search for specific objects and object features within an image, rather than requiring them to search for an entire image.

While methods, apparatuses, and computer-readable media are described herein by way of example, those skilled in the art recognize that methods, apparatuses, and computer-readable media for automatic image segmentation, classification, and analysis are not limited to the embodiments or drawings described. It should be understood that the drawings and description are not intended to be limited to the particular form disclosed. Rather, the intention is to cover all modifications, equivalents and alternatives falling within the spirit and scope of the disclosure. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include,” “including,” and “includes” mean including, but not limited to.

The disclosed system addresses the unmet need for an automated, optimized method to identify, characterize and match objects within images. Methods, apparatuses and computer-readable media are described for automated and adaptive image segmentation into objects, automated determination of object properties and features, automated determination connectivity between objects, mapping of object morphology and characteristics with object connectivity and communication, and automated searching and visual presentation of objects within images. The system disclosed herein allows for classifying and matching individual objects within an image in a manner that can be specified as independent of object orientation and size and identifying community structures in an image. Using the disclosed system, objects within single or multiple images can be compared and ranked for similarity in shape, features and connectivity.

Furthermore, the methods disclosed herein can be utilized for biological applications, such as classifying responses of human vascular cells to stimuli, in order to improve regenerative medicine strategies.

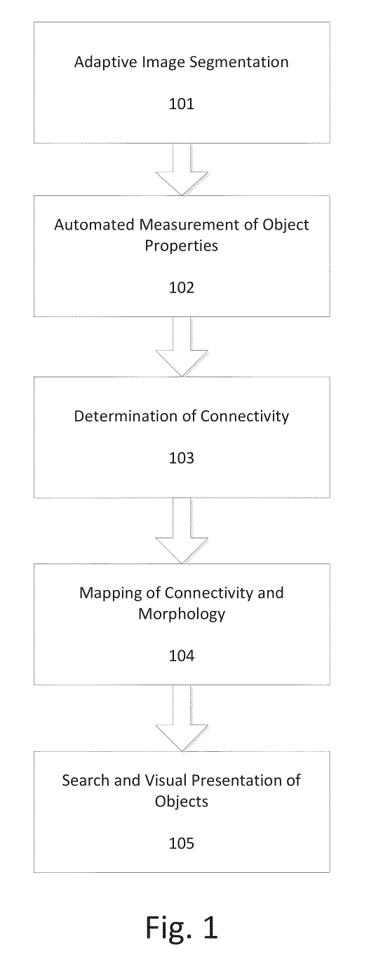

FIG. 1 illustrates an exemplary embodiment of the method disclosed herein. Each of these steps will be described in greater detail below. At step 101 adaptive image segmentation is performed. At step 102, the automated measurement of object properties is performed. At step 103, the connectivity between objects can be determined. At step 104 the mapping of object communication or connectivity and object morphology is performed. At step 105, search and visual presentation of objects is performed.

Of course, the steps shown in FIG. 1 are for illustration only, and can be performed in any order. For example, connectivity can be determined prior to an automated measurement of object properties. Additionally, the method can include additional steps or omit one or more of the steps shown in FIG. 1, as the steps in the flowchart are not intended to limit the methods disclosed herein to any particular set of steps.

Although many of the examples used throughout this specification refer to cells and other biological structures, the methods, apparatuses, and computer-readable media described herein can be utilized in diverse settings and for a variety of different applications. For example, the images can be taken from a video of people in some settings, such as a shopping mall, and the segmentation can be used to identify individual persons. In this case, the persons can be the image objects and the analysis can focus on the dynamics of person-to-person interaction within the particular setting. Within the biological arena, the images can correspond to an image of a biopsy and the system can be used to produce the identification and morphological metric sets for similar cancerous or benign cells and a measure of how they are connected. Other applications include predictions of the movement of vehicles, animals, or people over time. For example, the image objects can be cars on a highway, and the system can be used to model and analyze car-to-car connections and traffic patterns. Another application is that of predicting and tracking the presence of animals in particular region, such as a forested region.

### Adaptive Image Segmentation

Referring to FIG. 1, a process for adaptive image segmentation used in step 101 will now be described. As discussed earlier, prior image segmentation systems can be time-consuming, as they require significant user inputs and adjustments of image processing parameters, and biased, as they are often prone to both user error and variable interpretation of object boundaries. The adaptive image segmentation of the present application adaptively determines input and parameter values, which eliminates the need for user input in boundary definition.

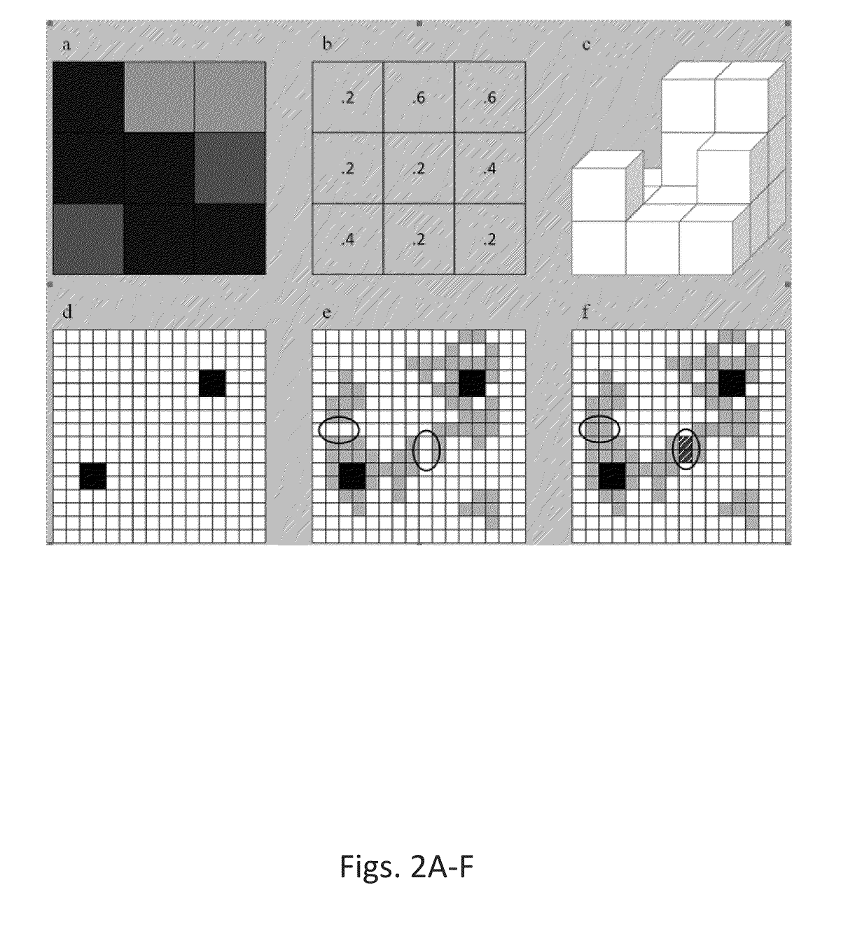

Image segmentation can be performed using the watershed method for simultaneous segmentation of all of the objects in an image. FIG. 2 illustrates an example of the watershed method applied to an image of cells and shows how the technique can be used to identify cell boundaries. In this topological version of the watershed method, each pixel in an image is interpreted as a grayscale value filling a space in a grid, as shown in part a. As shown in part b, each grayscale value is assigned a numerical value, such as a fractional value corresponding to the pixel intensity. This grid is transformed into a topography map with each space in the grid having a height proportional to the grayscale value of the pixel that it represents, as shown in part c. The topography map is then flooded by introducing water starting at elevation minima (represented by the black spaces in parts d-f of FIG. 2). These basins serve as starting points for the segmentation process by marking the individual elements in the image. As such, the markers and the distinct components of the image should be equal in number.

As flooding continues, the outline of the rising waterline will follow the rising contours of the map. During this process, it may be possible for separate, growing bodies of water to meet. If the two bodies originated from different original element markers, this junction region will define a boundary between unique objects in the image. On the other hand, the areas will unite to form a single body if they do not both originate from watershed starting points, or markers.

The flooding proceeds until all regions of the topography have been covered and the basins have been flooded to their edges. Finally, these edges, which can either be cell or image boundaries, are used define and isolate individual components of the image. The edges are shown in part f of FIG. 2 as striped boxes.

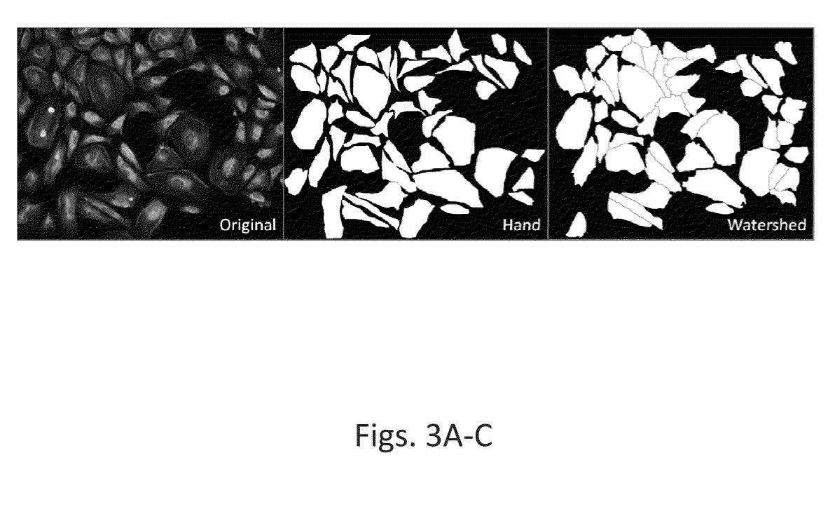

A comparison of the watershed image segmentation technique and manual object identification in an image is shown using the example of cells in FIG. 3. As can be seen, the watershed method used identifies many cell objects not shown in the hand drawn image segmentation.

While the watershed method lends itself nicely to simultaneous segmentation of all of the components in a single image, it is difficult to adapt for automated processing of multiple images. Many raw images require pre-processing and adjustment before the algorithm can effectively locate objects of interest in the field of view. Even when the images seem to be very similar, the properties of objects in one image may dictate the need for very different processing and parameter values than those required by another image. Even when staining and imaging conditions are tightly controlled, the properties of elements in one image may dictate the need for very different parameter values than those required by another image. For a further discussion of staining and imaging techniques for cell cultures, refer to “Predicting Endothelial Cell Phenotypes in Angiogenesis” authored by Ryan D T, Hu J, Long B L, and Qutub A A and published in Proceedings of the ASME 2013 2nd Global Congress on NanoEngineering for Medicine and Biology (NEMB2013), Feb. 4-6, 2013, Boston, Mass., USA, the contents of which are herein incorporated by reference in their entirety.

The present system provides an automated version of the watershed algorithm designed to execute image processing and perform segmentation for groups of images, eliminating the need for user input or adjustment for each image. The output of the watershed segmentation algorithm takes the form of masks, or binary representations of the area of the individual image components. These masks have the potential to be either too large or too small, and over represent or under represent the actual areas of the individual objects, respectively. The size, and accuracy, or these masks largely depends on the grayscale threshold value used to create a binary representation of the original image that aids in watershed implementation. The present system utilizes an adaptive threshold evaluation process that selects the optimal threshold value for segmentation by comparing a baseline binary representation of the original image and its objects to the areas of the generated component masks. The system iterates through the segmentation process by decreasing or increasing the grayscale threshold value until an acceptable area ratio between the baseline and the masks is reached, at which time the resulting masks are saved and the process moves on to another image in the queue. By automatically selecting the optimal threshold value, the process circumvents the need for manual input with each image that previously prevented automated processing of large image sets.

The system also incorporates improved methods for fine-tuning the generated masks that are not possible with traditional, single executions of the process. For instance, in many images, it can be difficult to discern ownership of borders between adjacent objects. For example, in biological cell images, cytoskeletal components can appear indistinguishable, bound via junctions. Alternatively, in images of humans, contact (i.e. hugging) can create similar problems when attempting to distinguish which features (i.e. clothing, limbs, etc.) belong to which individual.

In order to improve the potential for accurate segmentation, two watershed segmentation executions can be used in sequence. The first iteration can create masks of an underlying component feature that can serve as a baseline representation of the overall shape or area, but which typically does not extend to the true edges of the object. For example, in biological cell images, microtubules (a particular cytoskeletal element) do not always extend to the periphery of the cell, and are easily distinguishable for association with a particular cell. The resulting masks from this initial segmentation subsequently serve as the markers for the second iteration, which employs the final image. Since the initial masks will typically take up much of the actual cell area, the masks generated with final iteration only extend the borders slightly and refine them to match the actual contours of the image objects.

Additionally, the system includes the ability to output images to visualize the final, optimal masks for user review and reference. The program can also actively display during execution the effects of the grayscale threshold value adjustments on image pre-processing steps, as well as the generated mask areas. The user can also choose to create a movie to visualize in real-time the adaptive threshold value adjustments and their effects on mask generation and fine-tuning.

The adaptive, automated watershed segmentation system disclosed herein provides a method for segmenting images and identifying and isolating its individual components. It can be used with cells, such as human umbilical vein endothelial cells—HUVECs, but it amenable to other cell types, as well as co-cultures and three-dimensional assays. The system can also be useful in other types of image analysis, such as in the evaluation of micro-scale properties of biomaterials (i.e. collagen scaffold fibers), as well as applications requiring isolation of vehicles or human individuals from an image, such as for criminal investigations.

The system can be used to execute image processing and perform segmentation for large groups of images by eliminating the need for user input or adjustment for each image. This goal is accomplished by evaluating the accuracy of segmentation attempts associated with specific image pre-processing and watershed segmentation parameter values (i.e. grayscale threshold value), and adjusting these values accordingly in an attempt to find the optimal conditions required for effective segmentation. This prevents the need for user input and parameter adjustment, as well as biased boundary interpretation and segmentation evaluation, associated with many current segmentation techniques.

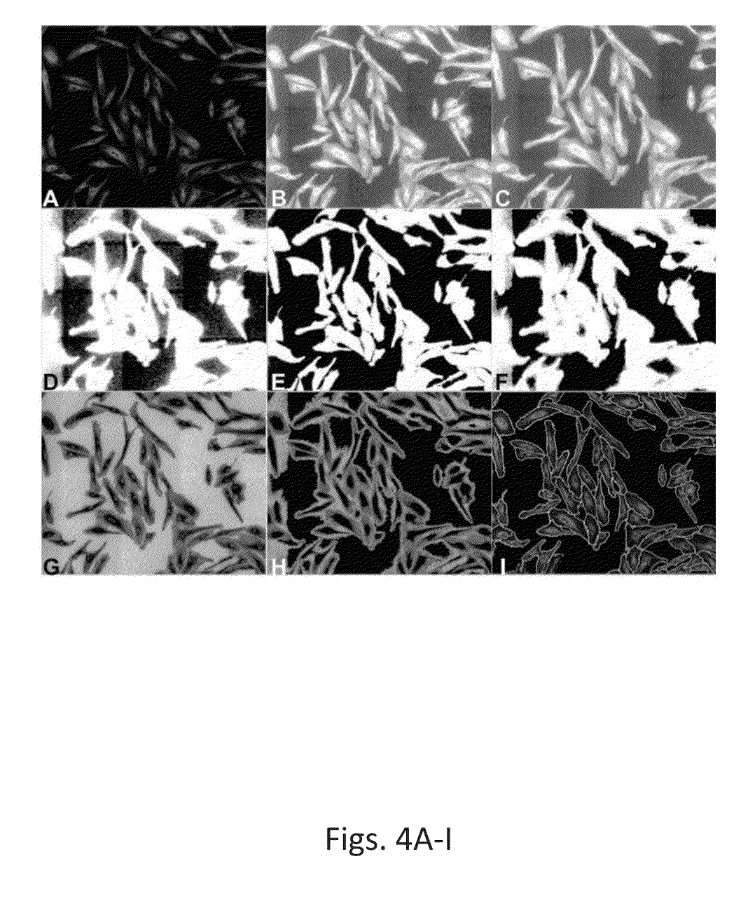

As explained earlier, watershed segmentation can involve many pre-processing steps. FIG. 4 illustrates some of the pre-processing steps that can be utilized by the system when performing watershed segmentation. These steps are described in greater detail in the outline of adaptive image segmentation provided below.

The first step can be the pre-processing of original image to prepare for watershed segmentation, which can include one or more of the following steps:

(a) selecting and defining markers of individual image objects,

(b) histogram equalization of an image, such as the original image,

(c) 2-D Gaussian filtering an image, such as the image produced by step (b),

(d) global image thresholding of an image, such as the image produced in step (c) with grayscale threshold value to create a binary image,

(e) removal of small objects in the binary image produced in step (d),

(f) generation of a finalized template for watershed segmentation by imposing the minimum of the combination the following:
i. Complement of binary image with values of 0 wherever either the marker image (a) or the final binary image previously created (d) have a value of 1, and
ii. Complement of the Gaussian-filtered image, and

(g) generation of a baseline binary image for area comparison via global thresholding of (c) with grayscale threshold value, which can determined by Otsu's method.

The second step can be the comparison of total mask area in the segmented image to the white area it shares with the baseline image, including one or more of the following steps:
(a) If the generated mask area is smaller than that of the baseline representation of the actual objects, the threshold value is decreased until the masks expand to the point where the total area of the masks is approximately equal to that of the white area shared with the baseline image,
(b) If the generated mask area is greater than that of the baseline representation of the actual objects, the threshold value is increased until the masks shrink to the point where the total area of the masks is approximately equal to that of the white area shared with the baseline image,
   i. Since we are looking for the smallest mask that will account for the entire actual object area, a threshold value can be selected and its segmentation results when any smaller threshold values yield masks with areas that are notably larger than the area of the baseline representation of the same object.

The first and second steps can then be repeated with the masks generated from the first iteration serving as the markers of the individual objects for the next segmentation cycle.

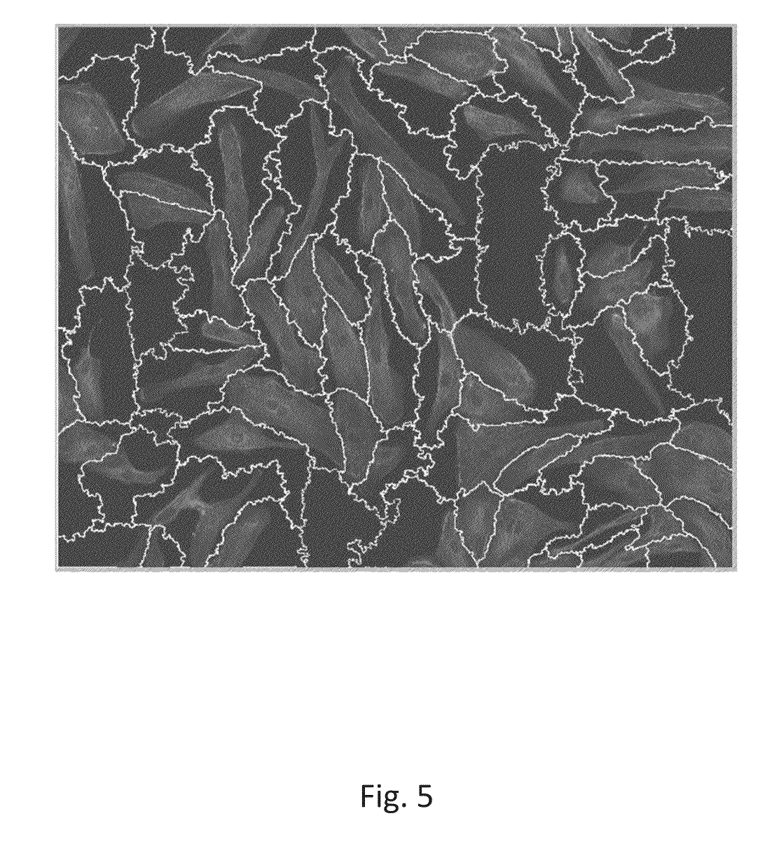

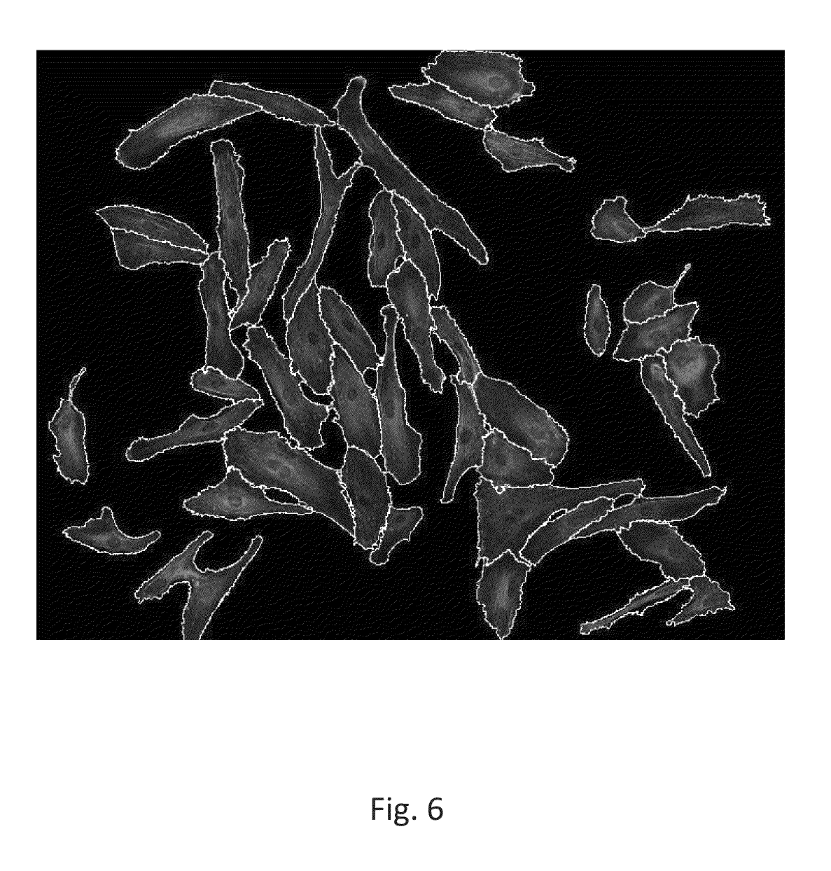

An output file can be generated, such as a TIFF file, with each layer representing a binary mask of an individual object in the image. Visualizations of segmentation effectiveness, segmentation iterations, and other similar information can also be output. The adaptive image segmentation is described in greater detail in Ryan, previously incorporated by reference. FIGS. 5-6 illustrates some results from successful automated image segmentation.

The user can define an area ratio value (between the baseline representation and the generated masks) that can serve as a threshold for designating acceptable segmentations. While a single ratio value will typically be suitable for all images of a particular type or set, this value can also be adjusted by the user when switching to different image set types. Alternatively, this value can be learned by the system based on previous image databases and image types. By analyzing sample image sets of cell types and determining appropriate area ratio value adjustments for optimal segmentations for these sets, the ratio can be automatically adapted when moving among image types. This adaptation can be a function of properties of the objects (i.e. cells) in the image set that are unique from objects in other image sets.

### Automated Measurement of Object Properties

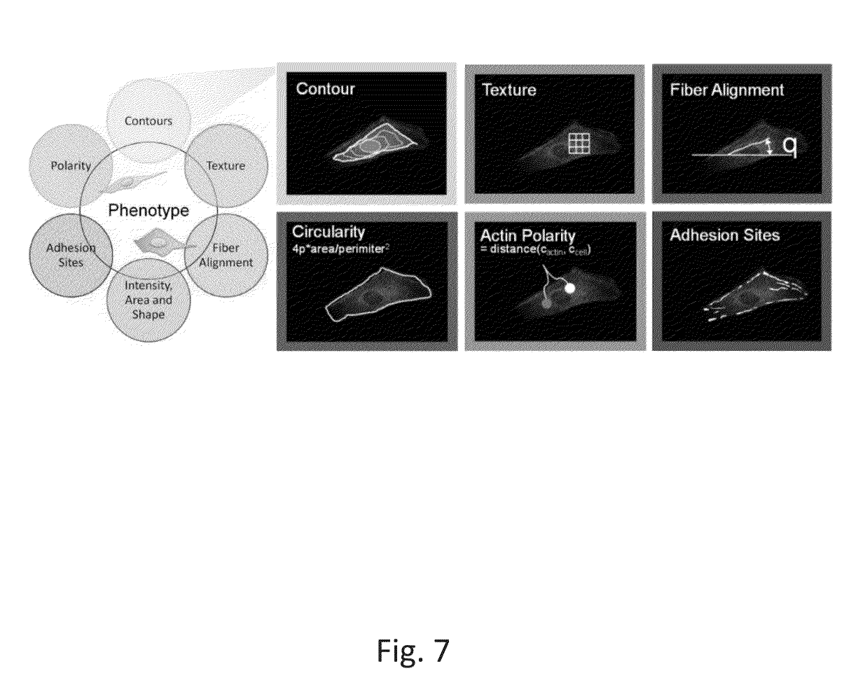

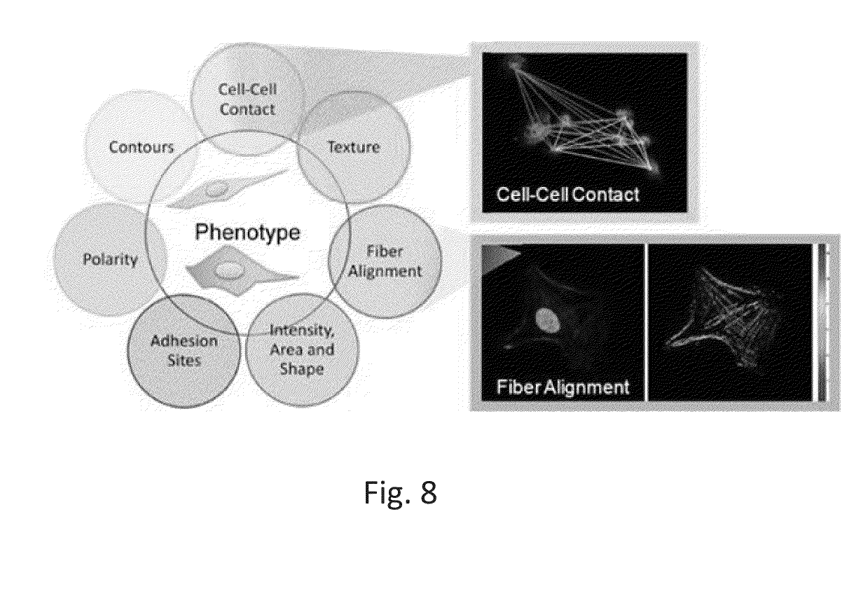

Referring to FIG. 1, the process for automated measurement of object properties used in step 102 will now be described. The disclosed system can utilize a variety of metrics targeted to measure the properties of the particular objects in the images being processed. For example, many metrics can be utilized which are optimized to recognize and measure properties of biological objects, such as cells including human endothelial cells and cancer cells. As shown in FIGS. 7-8, the metrics can include contouring, texture, polarity, adhesion sites, intensity, area and shape, fiber alignment and orientation, cell-to-cell contact and connectivity, and nuclear to cytoplasmic area ratio. These metrics allow measurement of alignment across objects (e.g., actin fiber orientation in cells), as well as characterization of spatial relationships of subfeatures (e.g., adhesion site comparisons).

The specific metrics will now be described in greater detail. Note that the descriptions below assume actin and microtubules or vinculin are stained using DAPI, but any other makers or stains can be substituted. These are illustrative but not inclusive metrics.

Exemplary contouring metrics can include:
MeanLocation AboveAvg—Mean Location of the stain weighted by the stain intensity (only considering locations with higher than avg stain intensity)
1. MeanLocation AboveAvg-Dapi
2. MeanLocationAboveAvg-actin
3. MeanLocationAboveAvg-vinculin
MeanLocation—Mean Location of the stain weighted by the stain intensity (percent radially away from cell centroid)
4. MeanLocation-dapi
5. MeanLocation-actin
6. MeanLocation-vinculin\
MaxLocation—Location corresponding to the max intensity of a stain
7. MaxLocation-dapi
8. MaxLocation-actin
9. MaxLocation-vinculin
MaxIntensity—Maximum intensity of the stain
10. MaxIntensity-dapi
11. MaxIntensity-actin
12. MaxIntensity-vinculin
Slope—Slope of stain intensity calculated from cell centroid to cell boundary
13. Slope-dapi
14. Slope-actin
15. Slope-vinculin

Exemplary texturing metrics are described below:
16. Co-occurrence Matrix, which can be described as follows:

$$Measures frequency of the spatial occurence of a pair of pixel intensities . \\ For each set of pixel pairs i and j , in a N \times N image , \\ if the image is a 8 \text{-} bit grayscale I = ε [ 0 , 255 ] . \\ {x}_{0} ( i , j ) is a center pixel and its neighbors are {\{ {x}_{k} ( i , j ) \}}_{k = 1}^{8}$$

$$P ( I , J ) = {\sum }_{i , j = 0}^{N - 1} s$$

$$Where s = \{ \begin{matrix}1 , if {x}_{0} ( i , j ) = I and {x}_{k} ( i , j ) = J \\ 0 , otherwise\end{matrix}$$

17. Mean—Average intensity of the stain
18. STD—Standard deviation of the stain, 6
19. Smoothness—

$$1 - \frac{1}{1 + {σ}^{2}}$$

20. 3rd Moment—Skewness of an image, given by:

$$\frac{{μ}_{3}}{{σ}^{3}}$$

21. Uniformity—Also referred to as energy:

Σp²
Sum of squared elements in the histogram counts of the image for pixel intensities. Analogous to energy or sum of squared elements in the grayscale co-occurrence ratty.
22. Entropy from Histogram—Measure of randomness of the image:
   22, Entropy from Histogram Measure of randomness of the image

−Σp+log₂(p)
Where p is the histogram counts of the image for pixel intensities, with 256 possible bins for a grayscale image.
23. Contrast—Intensity contrast of each pixel and its neighbors over the whole image:

$${\sum }_{i , j} {\vert i - j \vert}^{2} p ( i , j )$$

$$For a constant image , contrast = 0 , \\ p ( i , j ) = joint probability of a spatially \text{-} delineated pixel pair i and j having their respective grayscale values$$

24. Correlation—A measure of Pearson's correlation of each pixel to its neighborhood over the whole image:

$$A measure of {Pearson}^{′} s correlation of each pixel to its neighborhood over the whole image , \\ {\sum }_{i , j} \frac{( i - {μ}_{i} ) ( j - {μ}_{j} ) p ( i , j )}{{σ}_{i} {σ}_{j}} \\ For a perfectly linearly and positively correlated set of pixels , \\ correlation = 1$$

25. Energy—Sum of squared elements in the grayscale co-occurrence matrix

$${\sum }_{i , j} {p ( i , j )}^{2}$$

26. Entropy from GLCM—Entropy from the grayscale co-occurrence matrix, measures the randomness of the image.
27. Homogeneity—Measure of the closeness of the distribution of elements in the grayscale co-occurrence matrix to the diagonal of the matrix. For a diagonal matrix, homogeneity=1.

$${\sum }_{i , j} \frac{p ( i , j )}{1 + \vert i - j \vert}$$

Exemplary polarity metrics are described below:
28. Actin Polarity—Distance between center of mass of actin and centroid of the cell.
29. Vinculin Polarity—Distance between center of mass of vinculin and centroid of the cell.

Exemplary intensity, area, and shape metrics are described below:
30. Nuclear Std Dev
31. Viniculin Std Dev
32. Actin Std Dev
33. Nucleus Maj Axis
34. Nucleus Min Axis
35. Nucleus: Cytoplasmic Area Ratio
36. Viniculin: Nucleus SD Ratio
37. Actin: Nucleus SD Ratio
38. Viniculin: Nucleus Max Intensity Ratio
39. Actin: Nucleus Max Intensity Ratio
40. Viniculin: Nucleus Mean Intensity Ratio
41. Actin: Nucleus Mean Intensity Ratio
42. Circularity

$$\frac{4 π * Area}{{Perimeter}^{2}}$$

43. Elongation

$$\frac{Perimeter}{Area}$$

44. Nucleus: Cell Center of Mass

Exemplary adhesion site metrics are described below:
45. Adhesion Site Matching—The sum of the Euclidean distance between nearest neighbors of the COI (cell of interest) and a second cell (Cell 2) using COI adhesion site as reference plus Cell 2 as reference; the shorter the distance, the closer the match; COI compared to COI is an exact match.
46. Average Adhesion Site Area—Average adhesion site surface area
47. Total Adhesion Site Area—Sum of the surface area of all adhesion sites
48. Average Adhesion Site Major Axis
49. Average Adhesion Site Minor Axis
50. Total Number of Adhesion Sites

Exemplary actin fiber alignment metrics are described below:
51. Fiber Angle Peak Matching

Compares both the number of angle peaks and the percent of fibers aligned at each peak to the COI (cell of interest) fiber alignment metrics. The following equation defines how closely the fiber alignment in a patterned cells matches the COI. The lower the value the closer the match. For each original peak α0 in the cell of interest with its associated fraction of pixels ω0 (fractional area under the under for the peak), and all comparison peaks in the patterned cells, αi and their respective fractional weights ωi:

$$\sqrt{{\sum }_{i = 1}^{N} {( ( \frac{1}{1 - {( \frac{{ω}_{0} - {ω}_{i}}{1} )}^{2}} ) * ( {a}_{0} - {a}_{i} ) )}^{2}}$$

$${α}_{0} , {α}_{i} have units of degrees ; {ω}_{0 Z} and {ω}_{i} are fractions$$

$$N = total number of peaks in the patterned cell$$

### Determination of Object Connectivity

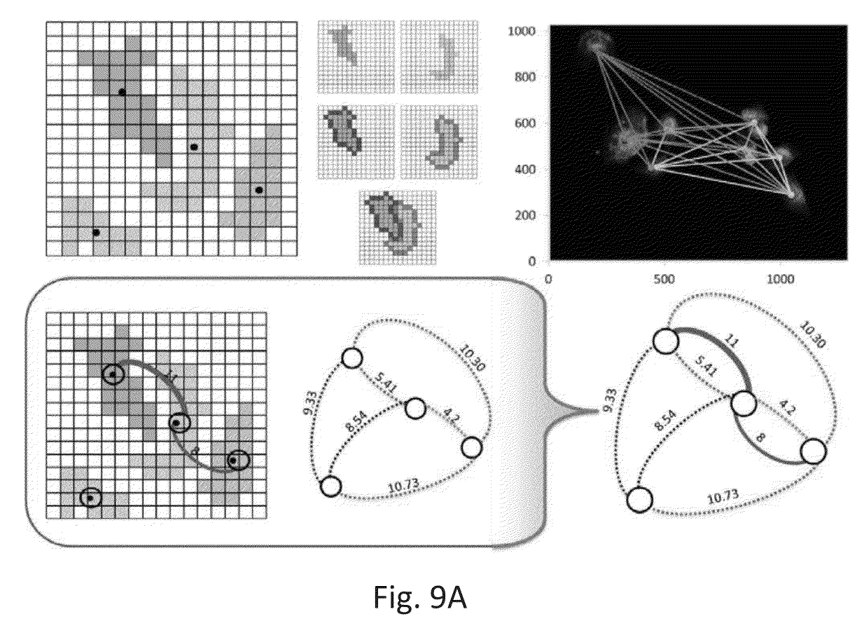

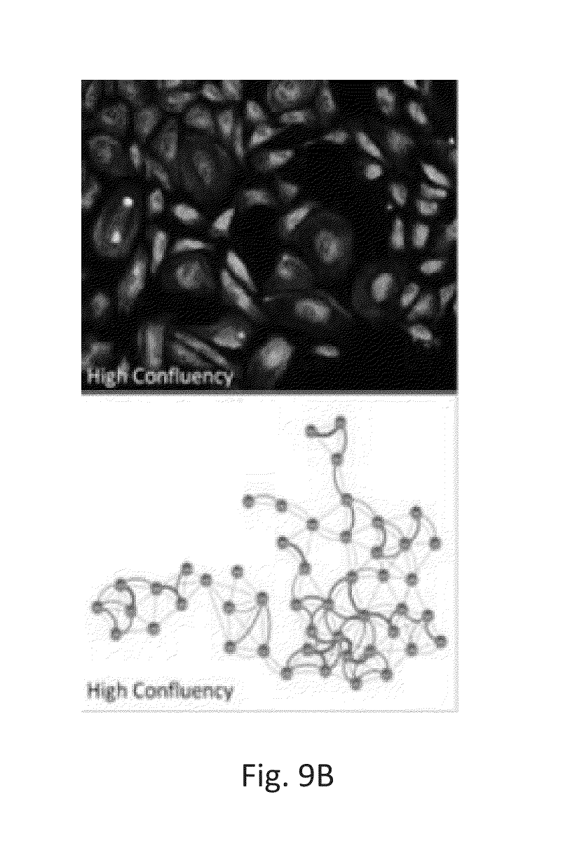

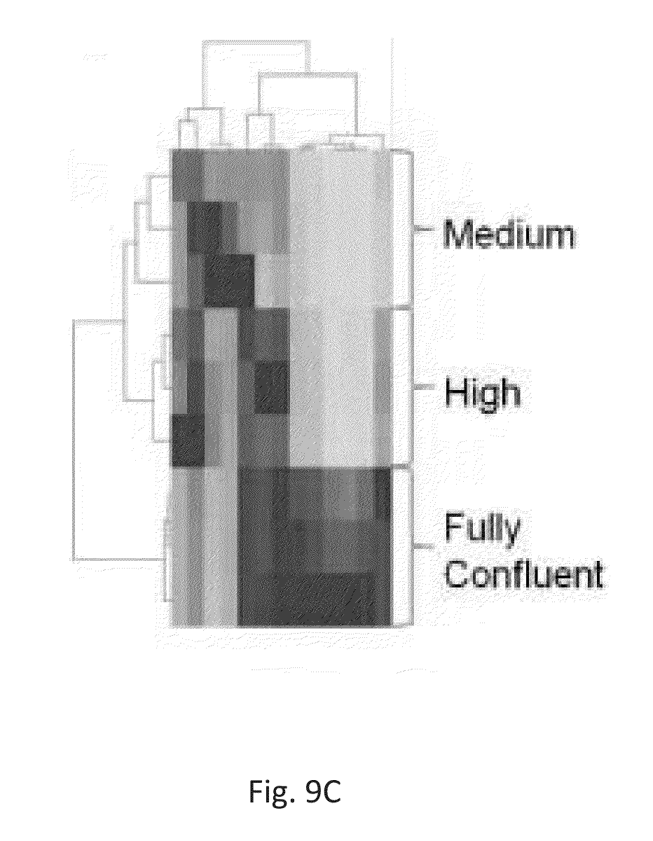

Returning to FIG. 1, the process for determining connectivity in step 103 will now be described. The present system can be used to model how information is propagated from objects within an image and to characterize modular/community structure. The object location and adjacency can be translated to a connectivity graph, as shown in FIG. 9. Adjacency can be measured by both object-object contact and distance between object centroids, and a weighted edge can be determined by these two values for each pair of objects within an image. Both global connectivity properties (e.g., graph centrality measures, neighborhood connectivity) and local object connectivity properties (e.g., degree, vertex centrality) can then be assessed. This method can also be used as an automated means to assess density of objects (e.g., confluence of cells) and heterogeneity in object density across the entire image. Additionally, the process allows for tracking of propagation of a perturbation or optimization of information passing from an object located in one region to another object in the image.

The process and system disclosed herein allows for the determination of connectivity and graph-based metrics which are means of measuring communication across objects (e.g., cell-cell communication, person-to-person interactions).

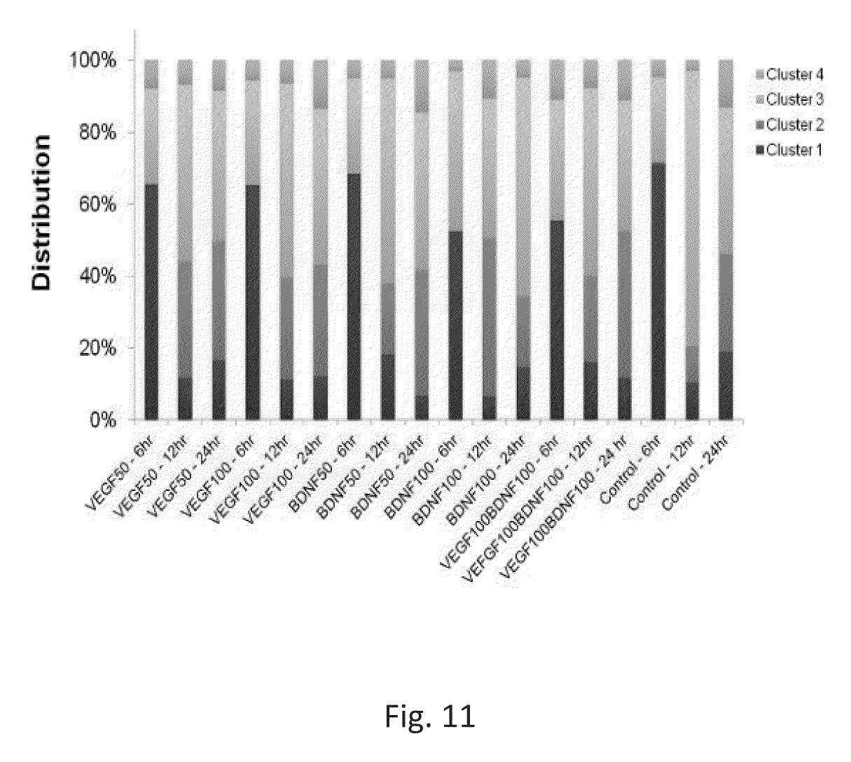

Users can define cutoff distances and/or a minimum number of shared pixels to seed the initial connectivity analysis. Alternatively, these values can be determined intelligently through domain specific analysis. Additionally, although the graphs shown in FIG. 11 are two dimensional, the graphs and connectivity analysis can be made three dimensional and can take into account hierarchical relationships.

### Mapping of Connectivity and Morphology

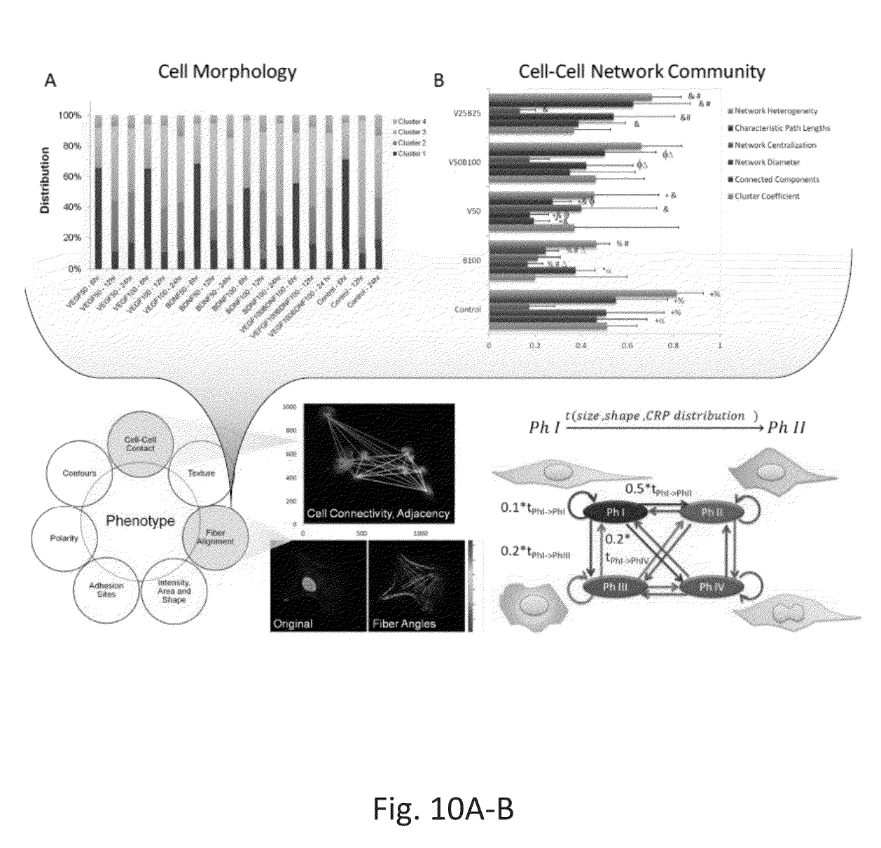

Referring back to FIG. 1, the process for mapping connectivity and morphology in step 104 will now be described. Clustering and/or machine learning can be used map an object's network properties to its spatial characteristics, as shown in FIG. 10. This enables the development of predictive, spatiotemporal models of an object's communication and morphological changes. Applications of this process include predicting how biological cells change shape over time as a function of their community structure (or tissue composition). Other examples are predicting the movement of specific subcategories of cars or animals in a city or forested region of interest, respectively.

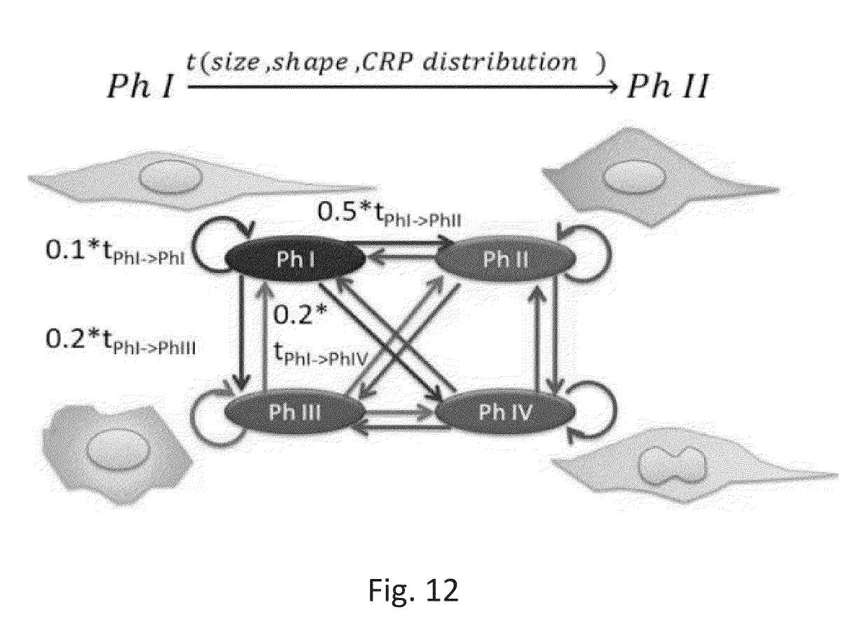

FIG. 11 illustrates an example of cluster analysis that can be used to develop predictive models and FIG. 12 illustrates an example of a predictive model, in the form of a probabilistic state machine. The mapping of features between connectivity and morphology can optionally be weighted, such that there is selective weighting. Weighting can be based on domain knowledge and be implemented by adding scoring criteria to the weights.

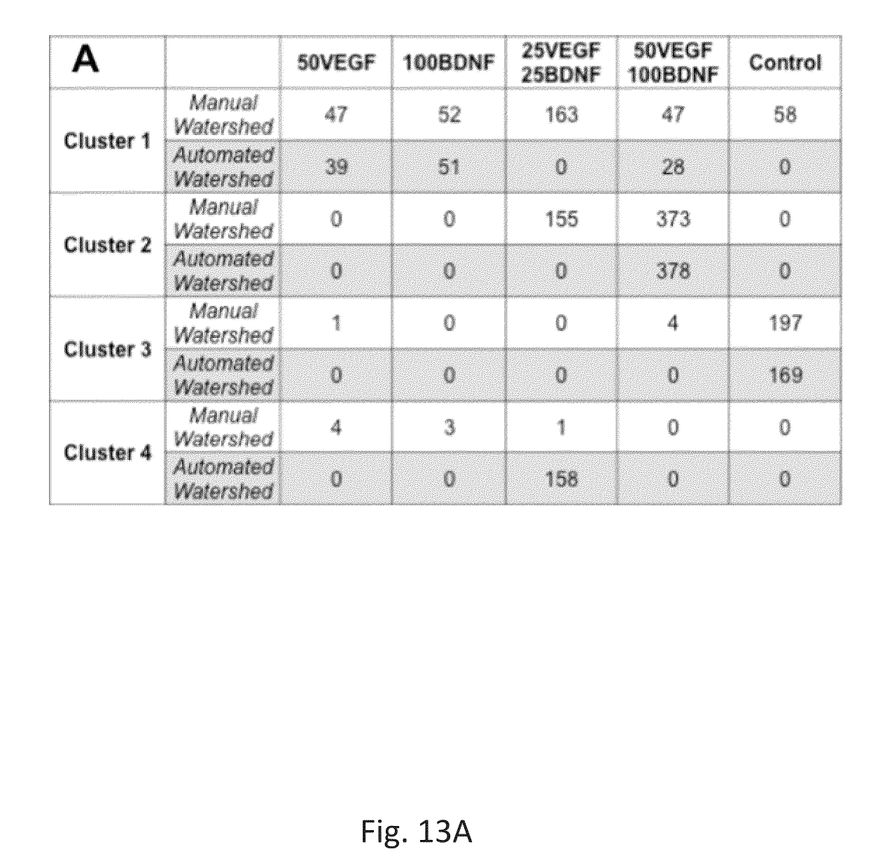

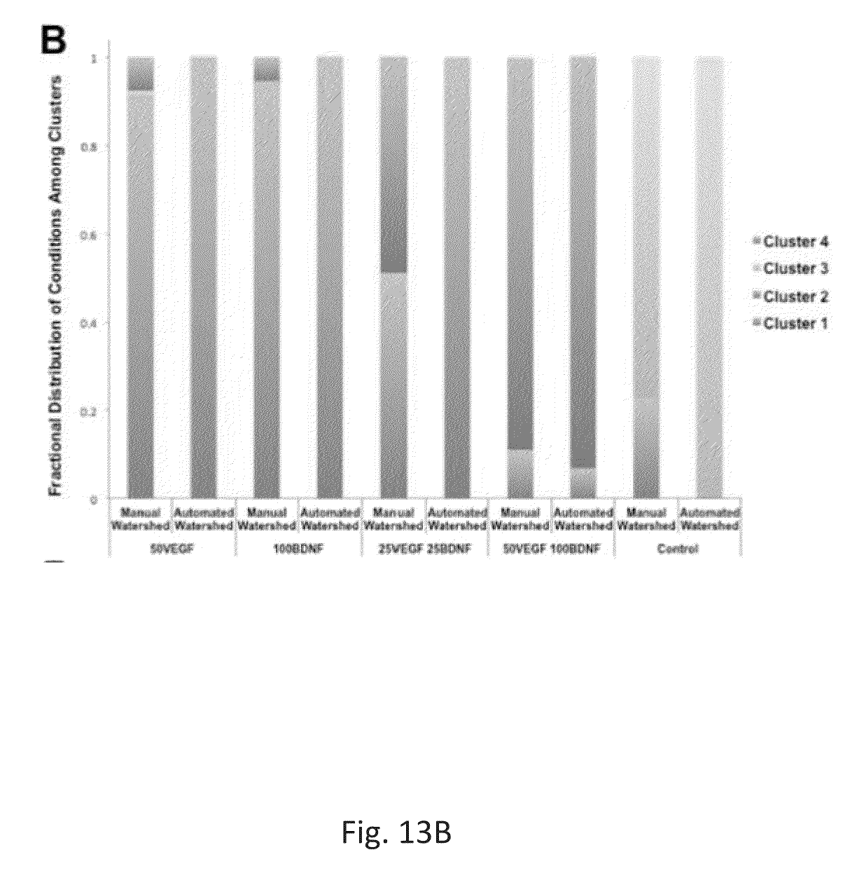

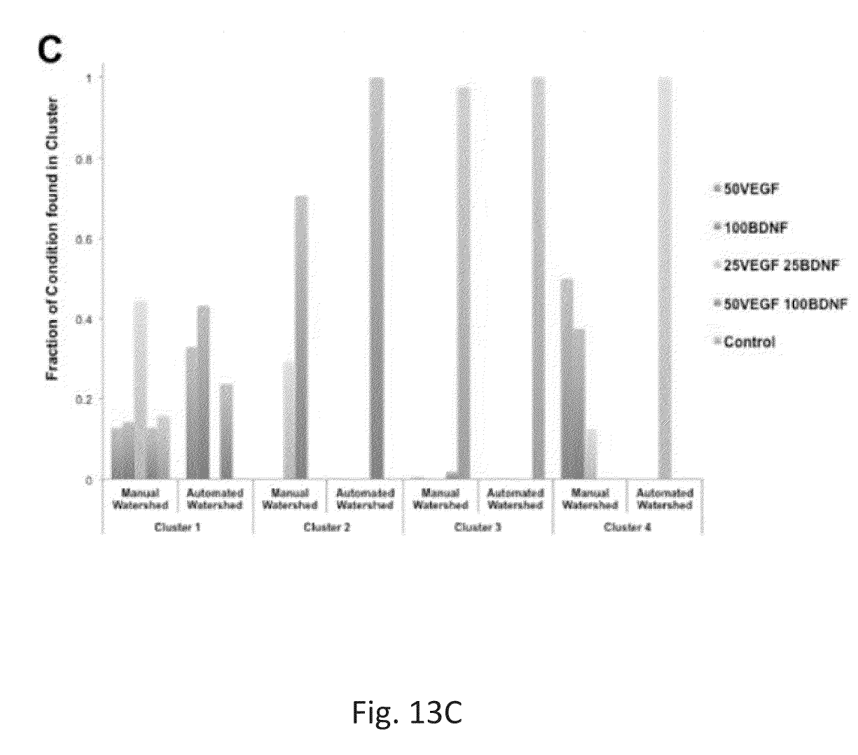

The system disclosed herein utilizes imaging, image analysis, and clustering to automatically categorize and define distinct cellular phenotypes or states. Users of the method and system disclosed can automatically categorize and define cellular states, or phenotypes, on a large scale and subsequently assign cells to these phenotypes based on their morphological responses to angiogenic stimuli. FIG. 13 shows a comparison of cluster analysis results from an automated watershed segmentation method as disclosed herein and the manual method.

### Search and Visual Presentation of Objects

Returning again to FIG. 1, the process for search and visual presentation of objects in step 105 will now be described.

Image or Object Search: The system can be used to perform an image search. For example, an image file can dropped into a folder or database, objects in the image can then characterized as described above, and the closest matches to an overall image and individual object matches can be returned by comparing feature sets and network connectivity. Unlike existing image searches, objects within multiple images can be compared and ranked for similarity in shape, features and connectivity. The image search can also be optimized for biological images, such as cells and tissues.

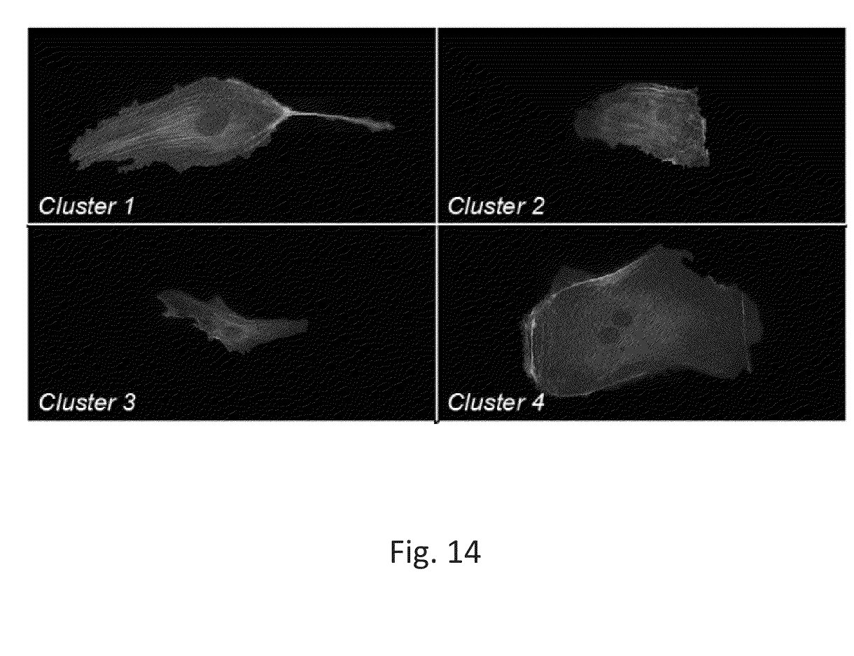

Merging of Objects: To assist in the interpretation of image classification, the system can be used to visualize an “average object” for each type of component in the image. To accomplish this, the system can align each segmented object in the same direction and overlay either all of the objects or a designated number of objects from each group or cluster in a single image, such as shown in FIG. 14 using the example of human cells. This merging, or overlay, of the individual objects shows common features and shapes through regions of high intensity and allows the user to infer the properties of the average object in a group.

The basic steps used to perform the merge process can be described as follows:
1. Overlay an object mask generated via the adaptive segmentation algorithm with the original image to yield an image of only the component of interest.
2. Align the long axis of the object with the x-axis of the image.
3. Crop the image to a smaller size (to save processing space).
4. Repeat steps 1-3 for each mask in the group of interest (or for a number of objects within the group of interest)
5. Adjust each individual object image so that they are all the size of the minimum-bounding rectangle for the largest cell in the sample, and so that they are all centered in the adjusted frames.
6. Overlay the individual objects one at a time in a single frame until all of the objects in the sample are merged into one image.

Generating a merged representation of similarly grouped objects allows users to visualize shared physical properties and represent the general appearance of an average object of a determined category. In cellular imaging, this is useful in visualizing common physical properties associated with identified morphological phenotypes, and how these features differ among the different phenotype groups. While generating average values of each metric used to quantify cells for all of the cells within a phenotype group can help represent the “average cell”, generating a visual representation of the average cell helps users better identify similar cells in images and associate them with particular phenotypes. This could be useful in the future in assessing the effectiveness of efforts to reproduce identical features; in cells or other applications such as biomaterials. Any deviations from a desired layout in the “average object” can represent an instance where the optimal solution was not reached.

As discussed earlier, this system can be used to classify responses of human vascular cells to stimuli, in order to improve regenerative medicine strategies. This system and method can also be applied to other areas, for example, to develop biomarkers of leukemia and to assess leukemic cells response to drugs, or to characterize the functional response of human neurons and neural stem cells to different microenvironments.

Users of the systems and methods disclosed herein can provide (such as by uploading or through some user interface) an image (.JPG, .TIF, .PNG) to a folder, GUI element, application, website, mobile app, or database, and the system can then automatically perform the steps described above.

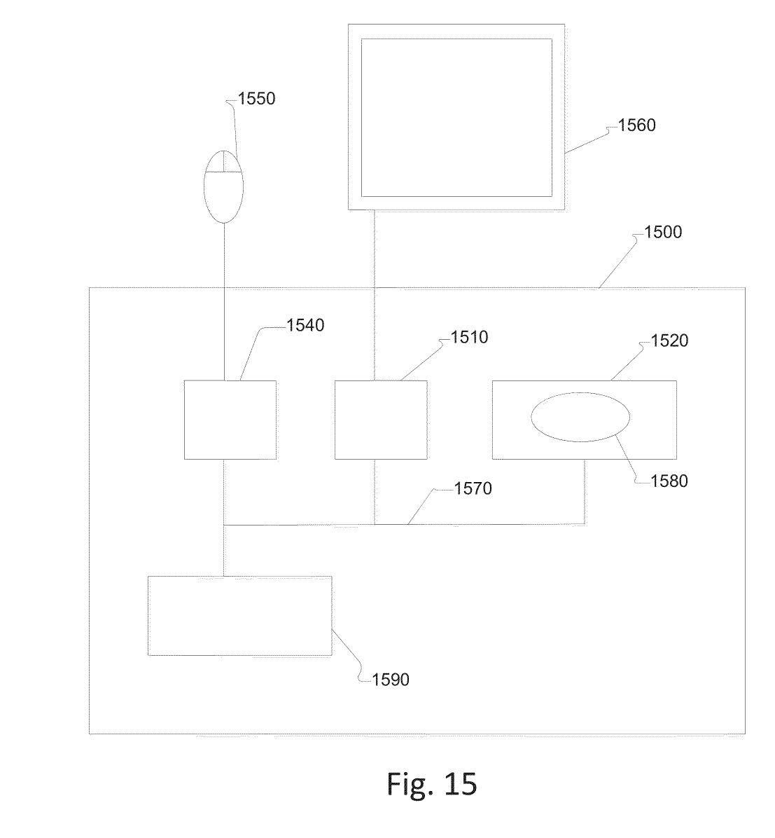

One or more of the above-described techniques can be implemented in or involve one or more computer systems. FIG. 15 illustrates a generalized example of a computing environment 1500. The computing environment 1500 is not intended to suggest any limitation as to scope of use or functionality of a described embodiment.

With reference to FIG. 15, the computing environment 1500 includes at least one processing unit 1510 and memory 1520. The processing unit 1510 executes computer-executable instructions and may be a real or a virtual processor. In a multi-processing system, multiple processing units execute computer-executable instructions to increase processing power. The memory 1520 may be volatile memory (e.g., registers, cache, RAM), non-volatile memory (e.g., ROM, EEPROM, flash memory, etc.), or some combination of the two. The memory 1520 may store software instructions 1580 for implementing the described techniques when executed by one or more processors. Memory 1520 can be one memory device or multiple memory devices.

A computing environment may have additional features. For example, the computing environment 1500 includes storage 1540, one or more input devices 1550, one or more output devices 1560, and one or more communication connections 1590. An interconnection mechanism 1570, such as a bus, controller, or network interconnects the components of the computing environment 1500. Typically, operating system software or firmware (not shown) provides an operating environment for other software executing in the computing environment 1500, and coordinates activities of the components of the computing environment 1500.

The storage 1540 may be removable or non-removable, and includes magnetic disks, magnetic tapes or cassettes, CD-ROMs, CD-RWs, DVDs, or any other medium which can be used to store information and which can be accessed within the computing environment 1500. The storage 1540 may store instructions for the software 1580.

The input device(s) 1550 may be a touch input device such as a keyboard, mouse, pen, trackball, touch screen, or game controller, a voice input device, a scanning device, a digital camera, remote control, or another device that provides input to the computing environment 1500. The output device(s) 1560 may be a display, television, monitor, printer, speaker, or another device that provides output from the computing environment 1500.

The communication connection(s) 1590 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the general context of computer-readable media. Computer-readable media are any available media that can be accessed within a computing environment. By way of example, and not limitation, within the computing environment 1500, computer-readable media include memory 1520, storage 1540, communication media, and combinations of any of the above.

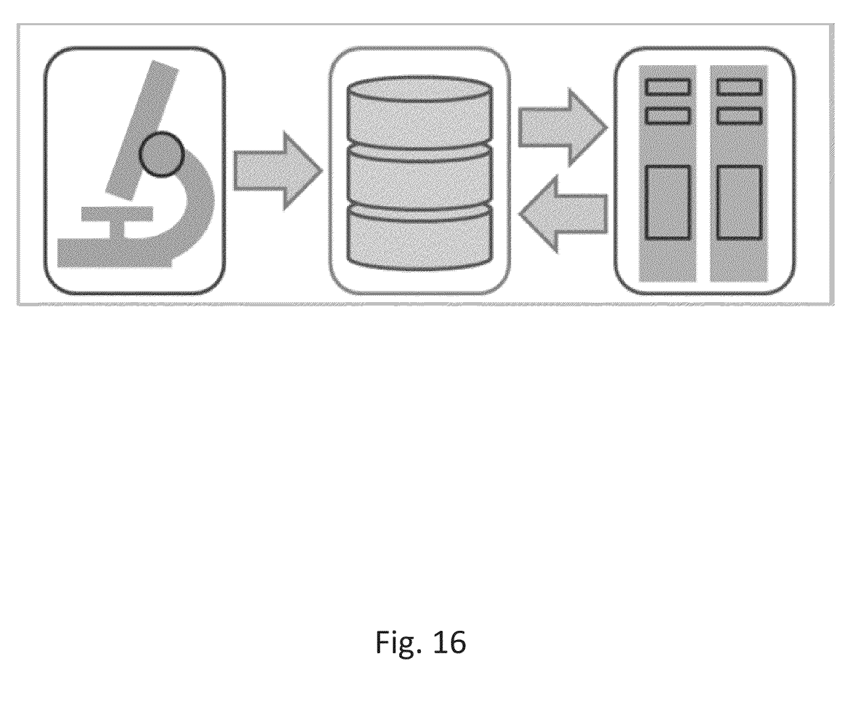

Of course, FIG. 15 illustrates computing environment 1500, display device 1560, and input device 1550 as separate devices for ease of identification only. Computing environment 1500, display device 1560, and input device 1550 may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing environment 1500 may be a set-top box, mobile device, personal computer, or one or more servers, for example a farm of networked servers, a clustered server environment, or a cloud network of computing devices. For example, computing environment may take the form of the computing infrastructure shown in FIG. 16.

Having described and illustrated the principles of our invention with reference to the described embodiment, it will be recognized that the described embodiment can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiment shown in software may be implemented in hardware and vice versa.

In view of the many possible embodiments to which the principles of our invention may be applied, we claim as our invention all such embodiments as may come within the scope and spirit of the following claims and equivalents thereto.

What is claimed is:

1. A method of identifying, classifying, and utilizing object information in one or more images by one or more computing devices, the method comprising:
receiving, by at least one of the one or more computing devices, an image comprising a plurality of objects;
segmenting, by at least one of the one or more computing devices, the image to identify one or more objects in the plurality of objects;
analyzing, by at least one of the one or more computing devices, the one or more objects to determine one or more morphological metrics associated with each of the one or more objects;
determining, by at least one of the one or more computing devices, the connectivity of the one or more objects to each other based at least in part on a graphical analysis of the one or more objects; and
mapping, by at least one of the one or more computing devices, the connectivity of the one or more objects to the morphological metrics associated with the one or more objects.

2. The method of claim 1, further comprising:
transmitting, by at least one of the one or more computing devices, a visual representation of the one or more objects.

3. The method of claim 2, wherein the visual representation is an aggregation of the one or more objects.

4. The method of claim 1, further comprising:
generating, by at least one of the one or more computing devices, a predictive model based on the mapping.

5. The method of claim 1, wherein the plurality of objects have an associated object type, and wherein segmenting the image comprises:
applying one or more image preprocessing steps to the image based on the object type; and
segmenting the image using a watershed method of segmentation.

6. An apparatus for identifying, classifying, and utilizing object information in one or more images, the apparatus comprising:
one or more processors; and
one or more memories operatively coupled to at least one of the one or more processors and having instructions stored thereon that, when executed by at least one of the one or more processors, cause at least one of the one or more processors to:
receive an image comprising a plurality of objects;
segment the image to identify one or more objects in the plurality of objects;
analyze the one or more objects to determine one or more morphological metrics associated with each of the one or more objects;
determine the connectivity of the one or more objects to each other based at least in part on a graphical analysis of the one or more objects; and
map the connectivity of the one or more objects to the morphological metrics associated with the one or more objects.

7. The apparatus of claim 6, wherein the one or more memories have further instructions stored thereon, that, when executed by at least one of the one or more processors, cause at least one of the one or more processors to:
transmit a visual representation of the one or more objects.

8. The apparatus of claim 7, wherein the visual representation is an aggregation of the one or more objects.

9. The apparatus of claim 6, wherein the one or more memories have further instructions stored thereon, that, when executed by at least one of the one or more processors, cause at least one of the one or more processors to:
generate a predictive model based on the mapping.

10. The apparatus of claim 6, wherein the plurality of objects have an associated object type, and wherein segmenting the image comprises:
applying one or more image preprocessing steps to the image based on the object type; and
segmenting the image using a watershed method of segmentation.

11. At least one non-transitory computer-readable medium storing computer-readable instructions that, when executed by one or more computing devices, cause at least one of the one or more computing devices to:
receive an image comprising a plurality of objects;
segment the image to identify one or more objects in the plurality of objects;
analyze the one or more objects to determine one or more morphological metrics associated with each of the one or more objects;
determine the connectivity of the one or more objects to each other based at least in part on a graphical analysis of the one or more objects; and
map the connectivity of the one or more objects to the morphological metrics associated with the one or more objects.

12. The at least one non-transitory computer-readable medium of claim 11, the at least one non-transitory computer-readable medium further comprising additional instructions that, when executed by one or more computing devices, cause at least one of the one or more computing devices to:
transmit a visual representation of the one or more objects.

13. The at least one non-transitory computer-readable medium of claim 12, wherein the visual representation is an aggregation of the one or more objects.

14. The at least one non-transitory computer-readable medium of claim 11, the at least one non-transitory computer-readable medium further comprising additional instructions that, when executed by one or more computing devices, cause at least one of the one or more computing devices to:
generate a predictive model based on the mapping.

15. The at least one non-transitory computer-readable medium of claim 1, wherein the plurality of objects have an associated object type, and wherein segmenting the image comprises:
applying one or more image preprocessing steps to the image based on the object type; and
segmenting the image using a watershed method of segmentation.
